(19) United States
(12) Patent Application Publication
(10) Pub. No.: US 2002/0145715 A1
(43) Pub. Date: Oct. 10, 2002

(54) Photographic package printing apparatus

(76) Inventors: Bjorn Alfred Godwin, N S W (AU); Kevin Purcell, North Shore (NZ)

Correspondence Address: BURNS DOANE SWECKER & MATHIS L L P, POST OFFICE BOX 1404, ALEXANDRIA, VA, 22313-1404, US

(21) Appl. No.: 09/495,948

(22) Filed: Feb. 2, 2000

(51) Int. Cl. G03B 27/52

(52) U.S. Cl. 355/55

(57) ABSTRACT

Disclosed is a device and method for upgrading a basic photographic printing machine to provide a package printing functionality.

The device has an optics carriage including a plurality of interchangeable lenses having different powers of magnification and interfacing means for controlling the arrangement of the lenses in response to control commands input by a user though a keyboard.

### FIELD OF THE INVENTION

The present invention is concerned with the field of machines that automatically print photographs from a transparency; such machines are often referred to as “mini-labs”. In particular the present invention is concerned with an upgrade kit which may be used in association with certain types of automatic printing machines in order to increase capabilities of those printing machines.

### BACKGROUND

The use of automatic photographic developing and printing machines is well known. These machines come in many different forms and with many different capabilities, however they may be divided according to functionality into those machines which are capable of “package” printing and those which are not. By package printing it is meant, without operator intervention, printing a number of images of different sizes from a single negative, the negative being held stationary so that the numerous images are printed from a single negative “pass”.

Such a capability is particularly useful for the production of sets of photographs of school pupils and weddings. This is because from a single negative, and in a single pass, it is possible to print a range of differently sized prints of the same image. Assortments of differently sized prints of the same image are frequently desired in the context of wedding and school photography. By printing such an assortment of differently sized images in a single negative pass the throughput of the apparatus is significantly increased. Furthermore, because all prints of the package are made at the one time, color balance is consistent throughout the whole order and paper wastage is minimized.

However, in general the costs associated with package printers are considerably higher than those associated with “basic” automatic photographic printers, i.e. those capable of only printing either a single image from a single negative pass or a plurality of identically sized images. Consequently, unless an operator of an automatic printing machine is sure that there will be a demand for package printing then he or she will normally purchase an automatic printing machine which lacks the package printing capability. However it may be that a demand for package printing grows so that the operator decides to risk additional outlay and so purchases a package-printing machine. Rather than entail such risk it is an object of the present invention to provide an upgrade kit for a basic automatic photographic printer machine in order to provide a basic machine with a package printing functionality.

### SUMMARY OF THE INVENTION

According to a first embodiment of the present invention there is provided a package printing upgrade apparatus for incorporation into an automatic microprocessor controlled photographic printer processor of the type producing prints of only one size from a single negative in a single negative pass, said microprocessor being responsive to commands of a command set input to said microprocessor by means of a keyboard coupled to said microprocessor:

said upgrade apparatus including:

a) Optics carriage means including a plurality of interchangeable lenses having different magnification powers, said carriage including motive means operative to interchange said lenses;

b) Interfacing means arranged to control said motive means and responsive to user control signals, said interfacing means arranged for interfacing with said microprocessor and producing commands from said command set;

c) A reduced command set input means generating said user control signals.

According to a second embodiment the present invention provides package printing upgrade apparatus for incorporation into an automatic microprocessor controlled photographic developing processor of the type producing prints of only one size from a single negative in a single negative pass, said microprocessor being responsive to commands of a command set input to said microprocessor:

said upgrade apparatus including:

a) optics carriage means including a plurality of interchangeable lenses having different magnification powers, said carriage including motive means operative to interchange said lenses; and

b) Interfacing means arranged to utilize a command set to synchronously control said motive means and said microprocessor by passing appropriate commands from the command set to the motive means and the microprocessor respectively at appropriate times in order to produce a print package.

According to a further embodiment, the present invention provides a package printing upgrade apparatus for incorporation into an automatic printing machine, said upgrade apparatus including:

a) A controller adapted to generate commands for controlling the operation of the printing machine and an optics carriage having a number of lenses; and

b) An interface means, for interfacing the controller with the printing machine and the lens carriage by forwarding appropriate commands to the printing machine and the optics carriage in order to synchronize movements of the lenses in the optics carriage with the printing functions of the printer, so as to produce a print package from a single negative pass.

Therefore it is apparent that the upgrade apparatus of the present invention is able to synchronize and interface its operation with that of an existing printer apparatus in order to simplify the printing of photographic packages.

In other words, the present invention enhances the function of standard mini-lab printers, as it allows operators to automatically print packages without the need for manually changing lenses and re-setting the printer between print sizes. In addition, the upgrade apparatus of the present invention increases the efficiency of the operation of the standard mini-lab printers, so that the rate of package printing output is markedly increased.

### BRIEF DESCRIPTION OF THE DRAWINGS

FIG. 1 depicts a typical mini-lab photographic printer processor unit with front panels removed.

FIG. 1A depicts a partial front plan view of FIG. 1.

FIG. 2 is a block diagram of the control system of the mini-lab unit of FIG. 1.

FIG. 3 is a block diagram of the control system of FIG. 2 further incorporating a package printing upgrade apparatus according to the present invention.

FIG. 4 is an exploded view of the controller board portion of the package printing upgrade apparatus of FIG. 3.

FIG. 5 is a view of the interface board portion of the package printing upgrade apparatus of FIG. 3.

FIG. 6 depicts the optics carriage portion of the package printing upgrade apparatus of FIG. 3.

FIG. 6A is a partial front plan view of the mini-lab unit of FIG. 1 wherein the fixed lens shown in FIG. 1A has been interchanged with the optics carriage of FIG. 6.

FIG. 7 is a schematic representation of the package printing upgrade apparatus of FIG. 3 interfaced to a mini-lab printer.

### DETAILED DESCRIPTION

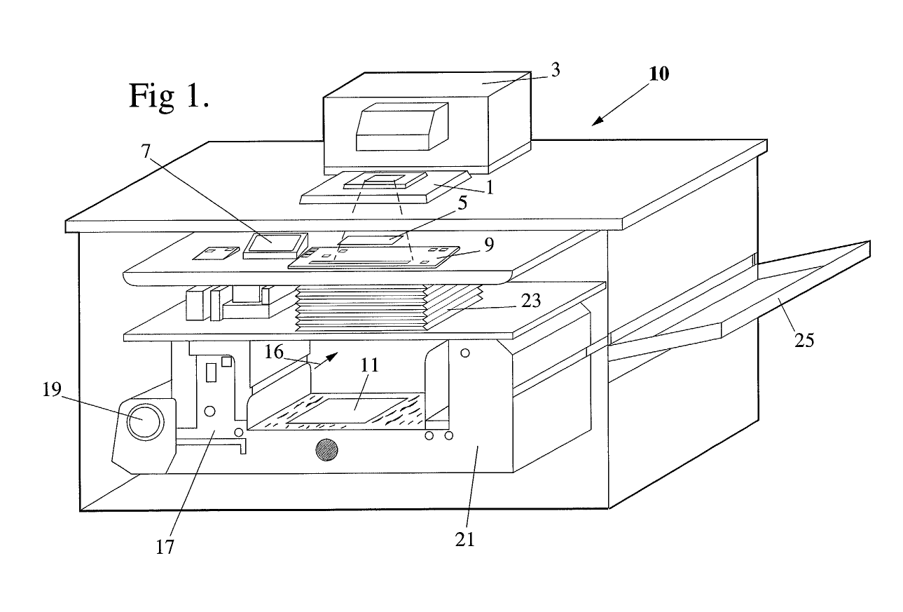

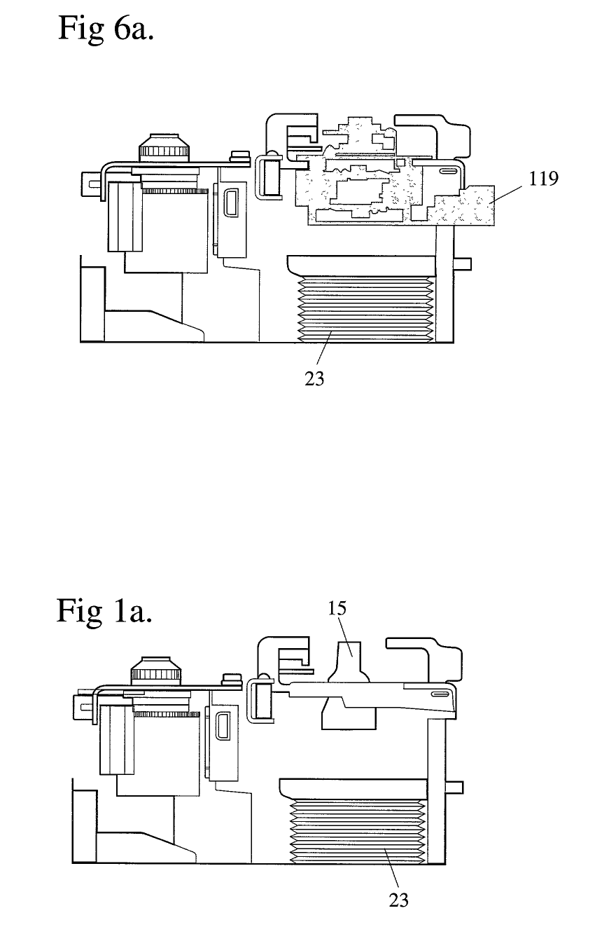

With reference to FIG. 1 and FIG. 1A, basic automatic photographic printing machines or “mini-labs”, such as the Konica series 808 printer processor, include a transparency mount 1, for holding a transparency such as a processed 135 color negative film as well as a light source mounted in hood 3 for illuminating a transparency positioned in mount 1. An image alignment window 5 for checking the alignment of an image formed on print paper 11 by lens 15, and a conveyor belt for advancing print paper 11. Print paper roll 19 is the supply of print paper 11 and cutting module 17 is used for cutting paper from roll 19 into sheets such as 11, while paper processing module 21 serves to fix the image formed on paper 11. Bellows 23 may be adjusted to accommodate lenses 15 having different lengths. Photographic printing machine 10 is microprocessor controlled by an operator with operator commands being input by means of keyboard 9 and commands confirmed and information output to the operator by means of LCD display 7.

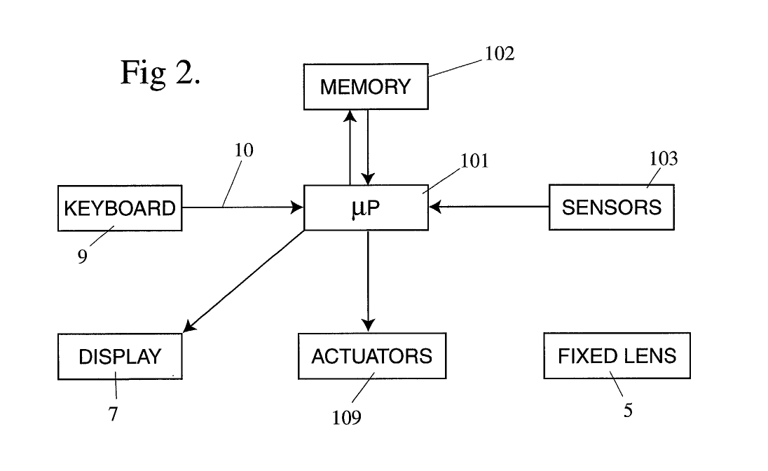

With reference to FIG. 2 there is depicted a functional block diagram of the printing machine of FIG. 1. It will be noted that the printing machine is based on a microprocessor 101 which runs an operating program stored in memory 102. Commands are entered by keyboard 9; other inputs may be taken from sensors 103, which may include data such as the position of the conveyor belt or the status of cutting module 17. Microprocessor 101 generates signals that control actuators 109; such actuators include servomotors for operating the conveyor belt.

In operation a negative, from which it is desired to produce printed images, is placed in mount 1. An image is formed by means of lens 15 upon paper 11 and that image is subsequently developed by paper processing module 21 and delivered to collection tray 25. It is possible to print different sized images by changing lens 15 and requesting the microprocessor to cut paper roll 19, by means of computer controlled cutting module 17 in order to produce differently sized print paper 11 however this procedure is very time consuming as will be seen from the following steps that have to be performed by the operator.

Step A. Initially the operator determines and sets the paper feed length and exposure position that corresponds with each of the fixed lenses that the operator has determined will produce the required print sizes. Those parameters are registered and saved in the Printer's memory using a series of manual keystrokes on the printer's keyboard i.e. 4 different print sizes require the saving of four different groups of settings.

Step B. The operator then selects a fixed lens 15 having a magnification appropriate to produce the required print size. The lens is installed into the printer and registered in the printer's memory 102. The processor matches the installed lens with the previously saved print size parameters.

Step C. The operator then manually presses the exposure key on the printer's keyboard 9 in order to instruct microprocessor 101 to start the printing process.

Step D. Printer 10 feeds the required paper size into the print exposure position by means of belt 13 and exposes the paper (e.g. paper 11) to produce an image.

Step E. the exposed paper is then conveyed to developing and paper processing module 21. The above process is repeated from step B for the next image size until the complete package of images has been produced. This procedure is very time-consuming requiring as it requires the manual inter-changing of lenses and extensive manipulation of the keyboard by the user.

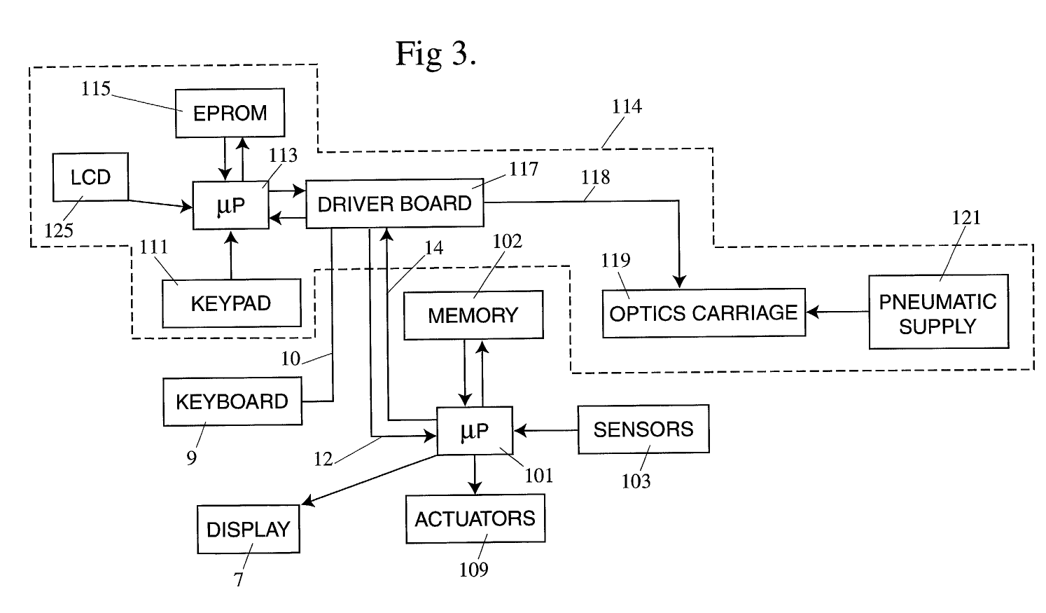

With reference to FIG. 3 there is illustrated a block diagram of the system of FIG. 2 incorporating a package printing upgrade apparatus 114, according to one embodiment of the present invention, demarcated by a dashed line in FIG. 3. This package printing upgrade kit 114 includes a keypad 111 which is coupled to a second microprocessor 113 which is preferably an 8 bit micro-controller based Central Processing Unit (CPU). This microprocessor 113 is in turn in communication with Read Only Memory 115, which is preferably an EPROM or Flash ROM. The EPROM preferably retains a plurality of programs or macros that allow microprocessor 113 to offer a wide range of possible packages for selection by an operator. Microprocessor 113 sends output signals to a driver board 117 which in turn is coupled to the keyboard input port of first microprocessor 101 in a manner to be explained. Driver board 117 also receives a cable 14 carrying a READY signal from microprocessor 101 which is relayed to microprocessor 113, preferably via an opto-isolator. The READY signal is used to initially synchronize the operation of upgrade kit 114 with that of mini-lab 10. A further output from the driver board is a multi-conductor cable 118, which connects to optics carriage 119.

Optics carriage 119 includes a number of slideable lens trays, each tray being selectively slideable from a first position to a second position by means of pneumatic actuators under the control of electrically controlled switches taking control signals from driver board 1 17. Pneumatic supply 121 generates a continuous supply of pressurized air to power the pneumatic actuators.

Upon the operator selecting which package is to be printed the microprocessor extracts the appropriate command set from the EPROM and sends these commands to the keyboard 9 on printer 10. These commands are then sent from keyboard 9 to the microprocessor 101 and memory 102 as if an operator were manually depressing the keys. The driver board then coordinates the passing of appropriate commands at the appropriate time to the printer and/or the optics unit carriage 119, in order to synchronize the lens movements in the optics carriage with the printing functions of the printer. This automated and synchronized procedure therefore eliminates the need for an operator to manually interchange lenses as was previously the case, and also does so at a much faster rate than a human operator could possibly work.

It is also to be appreciated that the present invention operates without requiring any determination of the computer code of the operating program contained in memory 102 of mini-lab 10. Rather the present invention emulates the signals that would normally be produced by keyboard 9 in order to produce the necessary printing functions of the mini-lab printer. Alternatively, if the computer code and communications protocol contained in memory 102 were known, microprocessor 113 would not have to emulate the signals in keyboard 9, but could communicate directly with printer microprocessor 101.

To enable the device of the present invention to operate the minilab printer via a dedicated communication port, the device would need to communicate the required operator instruction to the operating program (contained in the memory of the minilab printer) via this port utilising a predetermined protocol.

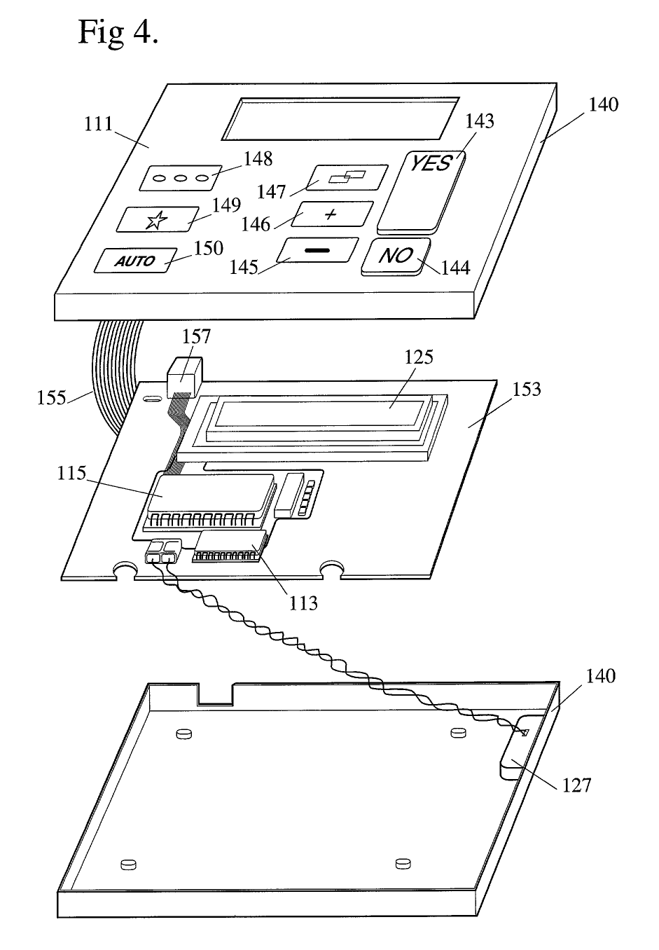

With reference to FIG. 4 there is depicted an exploded view of one embodiment of the control portion of the upgrade apparatus, the housing 140 of which contains a PCB 153 upon which is mounted LCD 125, microprocessor 113, EPROM 115 and connector 157. A maintenance battery 127 for preserving the code stored in EPROM 115 is located in the lower half of housing 140. The upper half of housing 140 mounts keypad 111 with keypad buttons 143-150, and contains a transparent window through which LCD 125 can be viewed. Keypad buttons 143-150 are connected to PCB 153, such as by ribbon cable 155.

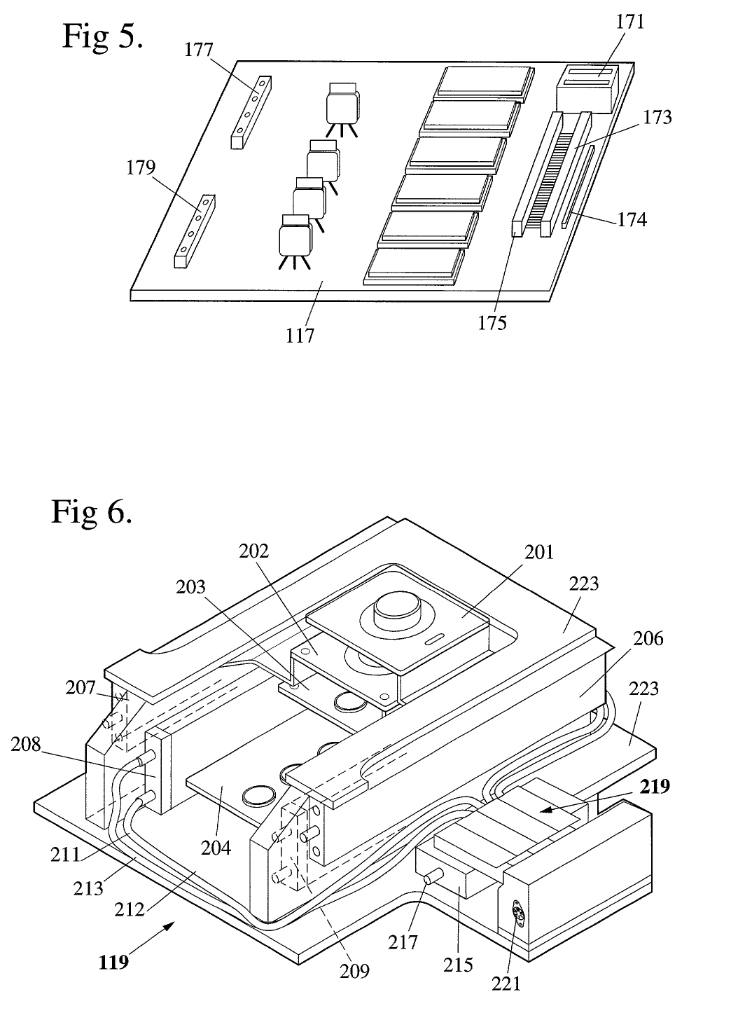

Referring now to FIG. 5, driver board 117 is depicted. The board includes a connector 171 for connection by cable to connector 157 on PCB 153 of the controller portion. An important function of driver board 117 is to direct the control signals from PCB 153 appropriately to optics carriage 119 and to the microprocessor of the mini-lab printing machine. The driver board includes voltage translator circuits for producing an output, at connector 179, suitable for controlling pneumatic switches on optics carriage 119. IDC connector 175 is connected to keyboard 9 via a ribbon cable 10 (shown in FIGS. 1 and 2). Connector 175 is connected in parallel with a second IDC connector 173 that receives a ribbon cable 12 (FIG. 3) which is in turn connected to a port of the printer's microprocessor 101. By this arrangement driver board 117 facilitates the insertion of command signals originating from the upgrade apparatus microprocessor 113 into the data stream to main microprocessor 101. Main microprocessor 101 receives and acts upon these additional commands as if they had originated in the standard manner from keyboard 9. Apart from the signals from the controller PCB 153 received at connector 171 the interface board also receives a READY signal from main microprocessor 101 by means of cable 14 (shown in FIG. 3). This READY signal is an internal clock type signal that initially pauses the mini-lab's operational functions. The controller monitors this signal via driver board 117 and uses it to initiate the synchronization of the commands it issues to both the printer and the optics carriage with the normal operation of the printer.

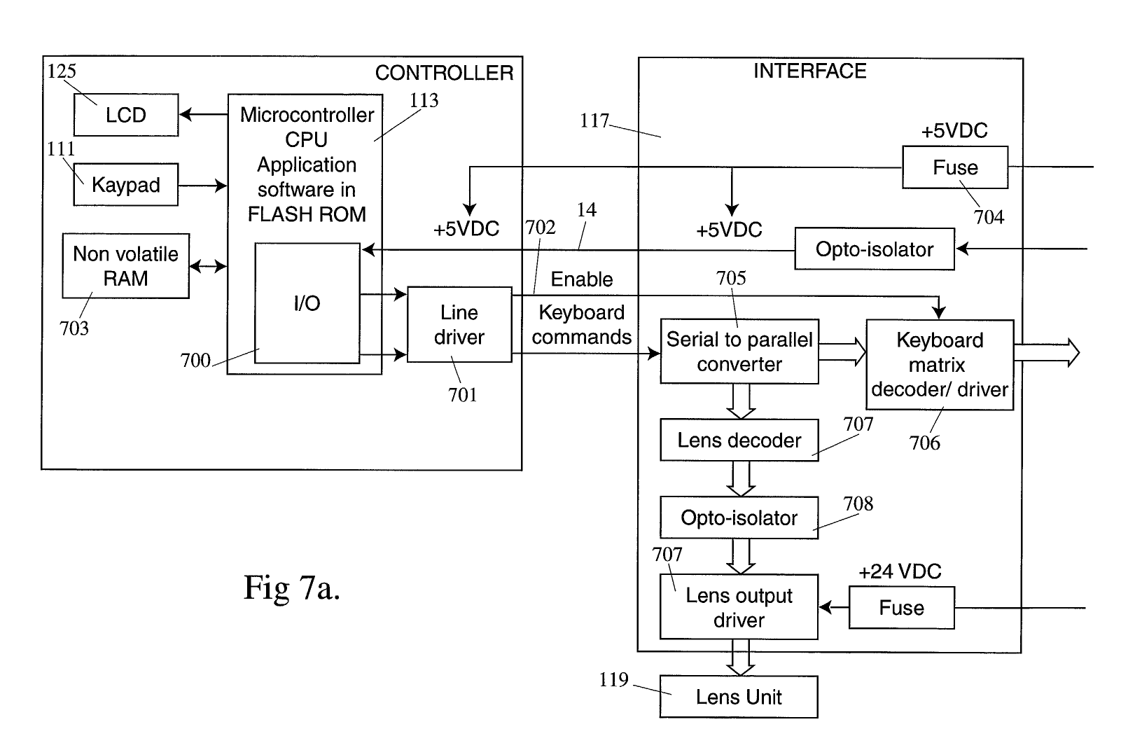

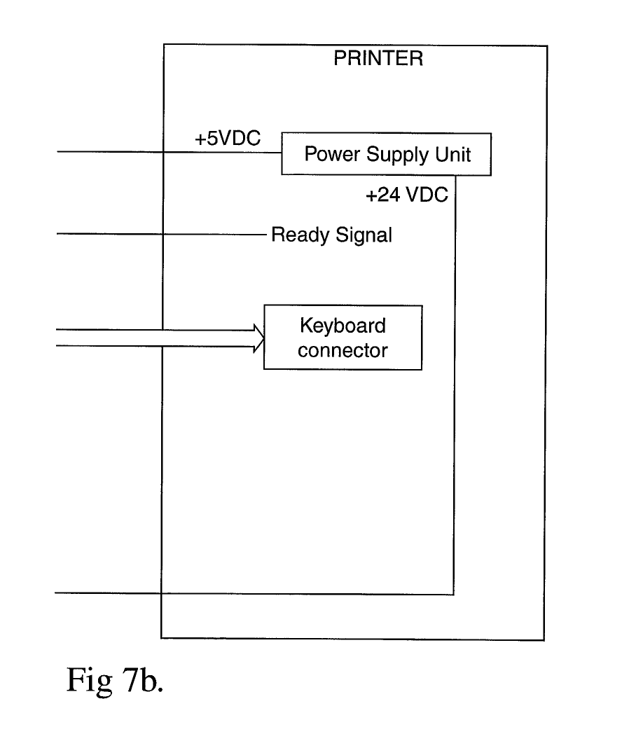

It is also to be noted that the controller and the circuitry of the driver board are preferably powered with 5 volts DC from the mini-lab printer via a fused connector 704 (see FIG. 7) on the driver/interface board 117.

With reference now to FIGS. 6 and 6A there is depicted an optics carriage 119 compatible with the present embodiment of the invention. Optics carriage 119 includes a number of slideable lens trays 201-204 each coupled to pneumatic actuators 206-209 respectively. Each of pneumatic actuators 206-209 is connected to two air cables. For example cables 211 and 213 are connected to actuator 208. The cables are then connected to a switchable air source 215 that is powered by connection of a pneumatic supply to inlet 217. The direction of air flow through each actuator 206-209, and thus the movement of each tray from one position to another, is selectable by means of four solenoids 219 coupled to air source 215 and connected to control signal port 221. The control signal port is in turn connected to terminal 179 of Driver Board 117, the connection being shown as line 118 in FIG. 3. Chassis 223 is shaped to complement the lens bay of mini-lab printer 10. Accordingly, it is a simple matter to remove fixed lens 15 from the printer and to install optics carriage 119 in its place as shown in FIG. 6A.

The optics carriage is controlled from the driver board 117 via an optoisolated lens output driver, which is preferably a 24 volt solenoid driver transistor. This output driver is powered separately from the other components on the driver board, preferably with 24 volts DC from a fused connection from the printer's power supply unit (see FIG. 7). Electrical connection between driver board 117 and pneumatic supply 121 is then made and a source of pressurized air is connected to pneumatic supply inlet 217.

Once installed, each of the lenses of lens trays 201-204 may be independently moved in and out of the light path created by mini-lab light-hood 3 by transmitting appropriate signals to control signal port 221. In the presently described embodiment lens tray 201 incorporates an 8×10 inch enlargement lens. Lens tray 202 has two 6×4 lenses. Lens tray 203 has one 5×7 lens and tray 204 has four wallet lenses. The above lens magnifications refer to the size of the images formed on print paper 11.

The operation of the system will now be explained with reference to FIG. 7, being a schematic diagram of a preferred embodiment of the components of the driver/interface board 117 and how these components interrelate with the components of the controller and a mini-lab.

Numerous keystrokes or macros are able to be stored in the ROM in order to operate the printer in various ways. It is also to be appreciated that the Non-Volatile RAM 703 allows the operator to store several different combinations of these macros in groups or packages for future request, such as packages P1-P4. For example P1 may consist of four wallet prints, two 6×4 and one 8×10 prints whereas P2-P4 will each consist of different combinations of print sizes. These macros would include, inter alia, the commands that would issue from keyboard 9 to forward print paper 11 an appropriate amount, as well as the corresponding position of the lens trays of the optics carriage.

An operator wishing to produce a particular package, say P2 will select P2 by means of keypad 111. The microprocessor 113, which manages presses of key pad 111, outputs the operator's selection to the LCD 125 under control of an application program retained in the CPU's ROM.

Therefore, upon an operator entering a request for a particular photograph package, the first appropriate macro is output via the CPU's I/O circuitry 700 and line driver 701 as a serial stream from two lines, being data and clock lines. The line driver is a balanced line driver to minimize external interference.

The interface board receives the stream of signals, where the signals firstly undergo a serial to parallel conversion in the converter 705, and separates the keyboard commands from the lens commands, where necessary. The keyboard commands are then forwarded to the keyboard matrix decoder 706 where the keyboard commands are arranged into an 8 bit×5 bit matrix of key presses. The lens commands are correspondingly forwarded from the converter 705 to the lens decoder 707. The commands are queued in the lens decoder 707 and the keyboard matrix decoder 706, where the commands await an activation signal from the controller via the enable line 702.

Once all of these commands have been acted upon, the process is repeated for all other macros in the requested print package.

For effective and optimal operation, the upgrade apparatus needs to be synchronized with the normal operation of the mini-lab printer. Initial synchronization is achieved by the upgrade apparatus monitoring the READY signal of the main microprocessor. Driver board 117 relays READY signal on line 14 to microprocessor 113. This signal is used to intially synchronize the upgrade apparatus with the printer, although further synchronization is required throughout the whole printing procedure.

In this regard, each command from the upgrade apparatus to the printer and the optics carriage needs to be synchronized to that of the standard operation of the mini-lab so that the commands received by main microprocessor 101 from interface board 117 are transparently accepted. The mini-lab printer will have processing delays that are due to the normal operation of the printer, such as delays between receiving one instruction and implementing that instruction, before it is able to compute the next instruction. These operational delays are accounted for in the upgrade apparatus by building in interface delays. These delays are stored in EPROM 115 and are used to synchronize or queue the commands from the driver board to the minilab microprocessor 101. The values of the interface delays will generally depend on the inherent delays in a particular model of mini-lab machine to perform each step in the printing procedure. Therefore, the interface delays will vary from one type of mini-lab machine to another.

The inherent delays may be determined by dividing the operation of the mini-lab into sequential stages. Between each stage there will be a certain delay during which further commands cannot be received by microprocessor. The approximate minimum value of these inherent delays may then be arrived at by experimentation, such as by a trial and error approach of varying delay parameters in order to find the shortest possible times for each of the individual delays.

In the presently described system, the following interface delays are used for interfacing to an 8012 mini-lab printer. In addition, example times are indicated, which, for the 808 Konica mini-lab machine, have been found by the inventor to optimize the package-printing throughput:

Before Ready Signal—Time period that the Upgrade Apparatus allows before it monitors the READY signal; 15×100 ms.

After Ready Signal—Time period between Driver Board 117 detecting a READY signal and issuing a command to main microprocessor 101; 10×100 ms

Key Down Time—Time period the Upgrade Apparatus takes to simulate the holding down of the mini-lab keyboard's keys 111; 5×5 ms

Key Up Time—Time the Upgrade Apparatus takes to simulate the release of the mini-lab keyboard's keys; 33×5 ms

Registration Delay—Time taken for the mini-lab to register each of the print sizes and their settings prior to printing. This time should be long enough for the data to settle in the mini-lab's registers but not overly long in order to reduce waiting periods (i.e. if the delay is too short the mini-lab will not receive all of the code, and if delay is too long it will cause unnecessarily long package printing times); 24×100 ms

Delay Before Print—Time period before the Upgrade Apparatus simulates the actuating of the print (exposure) keys command. This is used to delay the print command when printing multiple copies of the same size. It is required because there is no Registration Delay when printing multiple copes as the print size is already registered; 7×5 ms.

Delay Before Color—Time period before actuating the Color Keys. When using the color keys, this is an additional delay to the usual Registration Delay; 8×5 ms.

These delays are therefore used by microprocessor 113, for example, to issue appropriately timed enable signals via enable line 702 to the decoders 706 and 707 on interface board 117. Therefore, the controller will activate the decoders 706 and 707 at appropriate times, so that the decoders send appropriately timed commands to main microprocessor 101 of the printer and to optics carriage 119.

Main microprocessor 101 acts upon the commands received from interface board 117 as if they had actually been issued by keyboard 9 and directs its actuators, such as cutting module 17 and the driver of belt 13, to cut and forward print paper 11 by an amount corresponding to the image sizes produced by optics carriage 119. The end result of this operation being that a package, i.e. a number of differently sized images from the same negative held in transparency mount 1 are cut to size, printed, developed by module 21 and issued at output tray 25.

It will be appreciated by persons skilled in the art that numerous variations and/or modifications may be made to the invention as shown in the exemplary embodiments without departing from the spirit or scope of the invention as broadly described. The exemplary embodiment is therefore to be considered in all respects as illustrative and not restrictive.

We claim:

1. A package printing upgrade apparatus for incorporation into an automatic microprocessor controlled photographic developing processor of the type producing prints of only one size from a single negative in a single negative pass, said microprocessor being responsive to commands of a command set input to said microprocessor by means of a keyboard coupled to said microprocessor:
said upgrade apparatus including:
a) optics carriage means including a plurality of interchangeable lenses having different magnification powers, said carriage including motive means operative to interchange said lenses;
b) interfacing means arranged to control said motive means and responsive to user control signals, said interfacing means arranged for interfacing with said microprocessor and producing commands from said command set;
c) reduced command set input means generating said user control signals.

2. A package printing upgrade apparatus for incorporation into an automatic microprocessor controlled photographic developing processor of the type producing prints of only one size from a single negative in a single negative pass, said microprocessor being responsive to commands of a command set input to said microprocessor:
said upgrade apparatus including:
c) optics carriage means including a plurality of interchangeable lenses having different magnification powers, said carriage including motive means operative to interchange said lenses; and
d) interfacing means arranged to utilise a command set to synchronously control said motive means and said microprocessor by passing appropriate commands from the command set to the motive means and the microprocessor respectively at appropriate times in order to produce a print package.

3. A package printing upgrade apparatus for incorporation into an automatic printing machine, said upgrade apparatus including:
c) A controller adapted to generate commands for controlling the operation of the printing machine and an optics carriage having a number of lenses; and
d) An interface means, for interfacing the controller with the printing machine and the lens carriage by forwarding appropriate commands to the printing machine and the optics carriage in order to synchronize movements of the lenses in the optics carriage with the printing functions of the printer, so as to produce a print package from a single negative pass.

4. The upgrade apparatus of claim 3 wherein the optics carriage is a part of the upgrade apparatus.

5. The upgrade apparatus of claim 1 or 2 further including a control means, responsive to a user's input instructions, for providing the interface means with an appropriate command set to control the motive means and the microprocessor to produce at least one print package instructed by the user.

6. The upgrade apparatus of claim 1 or 2 wherein the command set includes delay parameters for limiting the passing of instructions by the interfacing means to the motive means and the microprocessor.

7. The upgrade apparatus of claim 1 or 2 wherein the apparatus is shaped to allow it to be placed in a lens bay of the automatic processor.
